(19) United States
(12) Patent Application Publication
(10) Pub. No.: US 2009/0159136 A1
(43) Pub. Date: Jun. 25, 2009

(54) VALVE ASSEMBLY

(76) Inventors: Martin O'Donnell, Solihull (GB); Leslie Frank Checkley, Birmingham (GB)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/913,642

(22) PCT Filed: May 3, 2006
(86) PCT No.: PCT/GB2006/001599

§ 371 Date: Nov. 25, 2008

(30) Foreign Application Priority Data
May 3, 2005 (GB) 0508945.3
May 25, 2005 (GB) 0510634.9
Apr. 7, 2006 (GB) 0607030.4
Apr. 21, 2006 (GB) 0607916.4

(51) Int. Cl. F24D 19/08; F16K 24/00

(52) U.S. Cl. 137/176; 137/197; 251/227; 251/321

(57) ABSTRACT

A valve assembly comprising a support body (10), a plunger assembly (11) movable relative to the support body in an axial direction parallel with a longitudinal axis of the plunger assembly and said plunger assembly being angularly movable relative to the support body about said longitudinal axis, seal means (34) to provide a fluid seal between the support body and plunger assembly when support body and plunger assembly are in a first position relative to one another, bias means (43) acting on the plunger assembly in said axial direction to urge the plunger assembly in a first direction relative to the support body towards said first position, a fluid flow passage (28) to allow flow of fluid through the valve assembly when the plunger assembly has been moved relative to the support body away from said first position, said support body and plunger assembly having associated therewith respective abutment surfaces (19,31) engagable with one another to hold the valve assembly in an open state when the plunger assembly has been moved relative to the support body in said axial direction away from said first position to a second position, said plunger assembly being angularly moveable relative to the support body when at said second position selectively to bring the abutment surfaces into mutual engagement to hold the plunger assembly in said second position and to release the plunger assembly for movement towards the first position under the action of the bias means.

This invention relates to a valve assembly for controlling fluid flow and in particular, though not exclusively, to a vent valve for release of gas from a fluid system, for example for venting air from a radiator of a central heating system. The invention provides also a heat exchanger assembly comprising a heat exchanger in combination with a valve assembly of the present invention.

One common type of domestic central heating system achieves heating by circulating heated water through radiators. It is a well know feature of systems of that type that disadvantageously air accumulates and becomes trapped in a radiator. This can significantly reduce the efficiency of the radiator for transferring heat to the surrounding environment.

For the purpose of venting air from a radiator it is common practice to provide the radiator with a screw-threaded aperture and plug at a position near to the top of the radiator. The plug typically has a square head which enables it to be rotated by a complementarily shaped key and moved to an open position for release of air. A disadvantage of this long established practice is that the plug can be difficult to turn. Also, frequently the necessary key will have been misplaced, leading to a delay in being able to vent the radiator and return it to efficient operation. Furthermore there is the risk that the plug may be unscrewed too far, such that it ceases to occupy the aperture, and thus resulting in an uncontrolled flow of water from the radiator until the plug can successfully be relocated.

The present invention seeks to provide an improved valve assembly and also an improved heat exchanger assembly in which at least some of the aforedescribed disadvantages of known arrangements are mitigated or overcome.

According to one aspect of the present invention there is provided a valve assembly comprising a support body, a plunger assembly movable relative to the support body in an axial direction parallel with a longitudinal axis of the plunger assembly and said plunger assembly being angularly movable relative to the support body about said longitudinal axis, seal means to provide a fluid seal between the support body and plunger assembly when support body and plunger assembly are in a first position relative to one another, bias means acting on the plunger assembly in said axial direction to urge the plunger assembly in a first direction relative to the support body towards said first position, a fluid flow passage to allow flow of fluid through the valve assembly when the plunger assembly has been moved relative to the support body away from said first position, said support body and plunger assembly having associated therewith respective abutment surfaces engagable with one another to hold the valve assembly in an open state when the plunger assembly has been moved relative to the support body in said axial direction away from said first position to a second position, said plunger assembly being angularly moveable relative to the support body when at said second position selectively to bring the abutment surfaces into mutual engagement to hold the plunger assembly in said second position and to release the plunger assembly for movement towards the first position under the action of the bias means.

The term angular movement is used herein to embrace rotational movement through at least 360° as well as rotational movement through less than 360°.

Preferably the valve assembly comprises guide means to inhibit or restrict relative angular movement between the support body and plunger assembly over at least part of the length of axial movement of the plunger assembly relative to the support body from said first to said second position.

It is not essential that the guide means inhibits all said angular movement between the first and second positions. Thus the guide means may allow some angular movement but preferably that is less than the angular movement which is possible when the plunger assembly is at said second position.

The guide means may be integral with a portion of the valve assembly which defines a said abutment surface.

The guide means may comprise a formation such as a rib or lug which extends from one of the support body and plunger assembly. An end region of said formation may serve as a said abutment surface.

In a preferred embodiment the guide means inhibits or restricts relative angular movement when the plunger assembly is at said first position or is between said first and second positions, and allows relative angular movement when the plunger assembly lies at or beyond said second position.

The bias means may, for example, comprise a resilient component such as a helical compression spring.

The support body may be provided with a recess to accommodate at least a part of the bias means. Said recess may be an annular recess which contains part of the plunger assembly.

A collar may be provided between a portion of the plunger assembly and a portion of the support body. Said collar may extend around the bias means. The collar may be circumferentially discontinuous whereby it may be removed and replaced from around the plunger assembly and/or bias means. The collar may be provided with a slit which extends longitudinally.

The collar may be flexible. It may be flexible in consequence of the manner in which two or more collar sections are interconnected or in consequence of flexibility of the material from which it is formed. The collar need not necessarily be flexible, and may comprise two or more substantially rigid sections which can be selectively separated and re-united for removal from and relocation between the plunger and support body.

Preferably the axial length of the collar allows the plunger assembly to be moved relative to the support body only by a distance less than the distance between said first and second positions. Accordingly, in order to move the plunger assembly relative to the support body to lie in said second position it is necessary first to remove said collar. Thus, more generally, the present invention provides that the valve assembly may comprise a selectively removable limit device which in a first condition allows a plunger assembly to be moved only part of the distance from said first to said second position but which allows movement to the second position when in a second condition.

The valve assembly may comprise locking means to retain the valve assembly in said first, closed position until the locking means is released. The locking means may, for example, comprise a notch defined in part by the guide means and into which part of the plunger assembly may be rotated. In consequence the seal means may be retained closed despite any negative, below atmospheric, pressure that might arise in use when part of a central heating system is drained.

In addition or a an alternative to said collar or like limit device the valve assembly may comprise a safety lock member which in situ acts in a manner similar to the locking means described in the preceding paragraph to retain the valve assembly in the closed position but is selectively removable to allow opening of the valve for fluid flow therethrough.

The safety lock member may comprise two sections of generally semi-cylindrical shape and which may be selectively positioned between the plunger head and support body to prevent inwards movement of the plunger head towards the support body. The two sections may be moulded from plastics material and may be integrally interconnected by a thinner plastics region which serves as a hinge to allow opening and closing of the safety lock member. One section may have a tongue formation with an enlarged end that can be held captive by a mouth formation on the other of the two sections.

Location means may be provided for interconnecting the bias means and plunger assembly in a manner that allows the bias means to exert a bias force on the plunger assembly. In the case of use of a compression type bias means said location means may be provided by a head portion of the plunger assembly, for example an annular abutment face at said head portion. Preferably said head portion is, in use, an outer head portion which, in use, lies external of the fluid path to which the valve assembly is connected.

The fluid flow passage of the valve assembly may be defined by a passage formed at least in part within the support body and/or the plunger assembly. Preferably it is defined by a space between confronting surfaces of the support body and plunger assembly.

An outer head portion of the plunger assembly preferably is provided with a knurled, hexagonal or other non-circular outer profile to assist rotation without the need to employ a key or like tool for effecting angular movement between the plunger assembly and support body when in said second position.

The support body may be in the form of a boss having a screw-threaded formation for attachment to part of a fluid flow path, such as a screw-threaded aperture in a radiator. A fluid seal may be achieved in a conventional manner between confronting screw-threaded surfaces or the boss may comprise an abutment face for a seal such as an O ring seal which, in an assembly, is compressed between the abutment face and structure of the fluid flow path.

For the purpose of providing a fluid seal when the plunger assembly is in said first position relative to the support body preferably a seal member such as an O ring seal, is provided therebetween. The seal may be retained relative to one of the confronting surfaces of the plunger assembly and support body between which it is operable to effect a seal, or may be free to contact either of the confronting surfaces, or rest therebetween, when the valve assembly is in a fully or partially open condition.

The outer diameter of the support body preferably is less than 5 centimetres. In the case of a support body having a screw-threaded outer formation the diameter of said screw-threaded outer formation preferably is less than 2.5 centimetres, more preferably less than 2 centimetres.

Embodiments of the present invention will now be described, by way of example only, with reference to the accompanying diagrammatic drawings in which:—

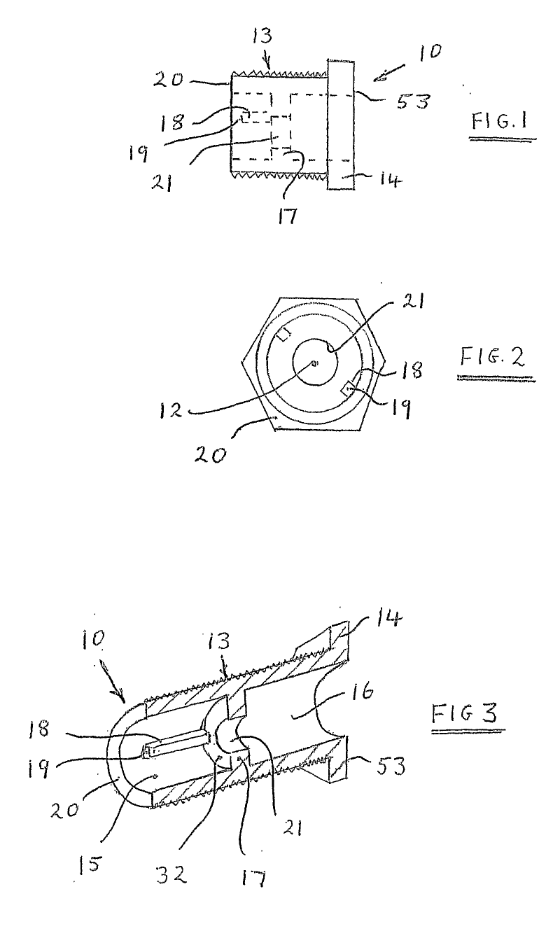

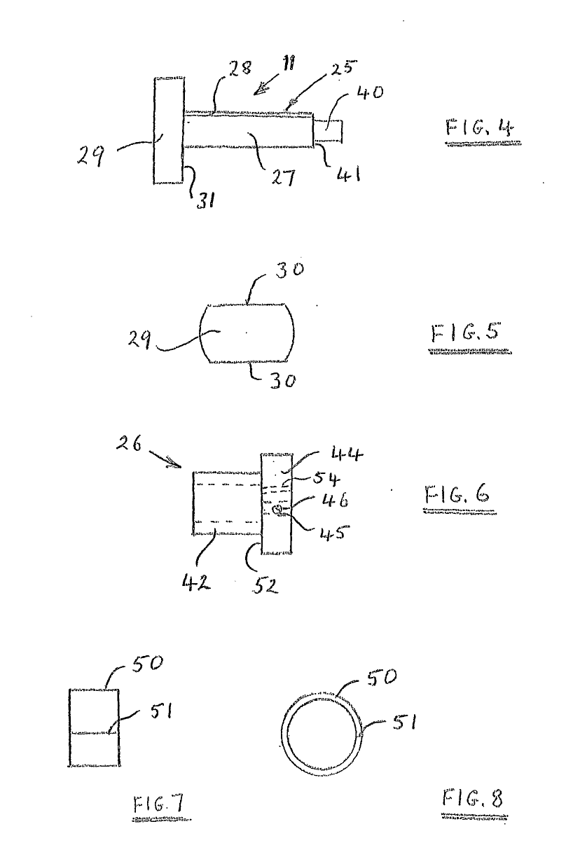

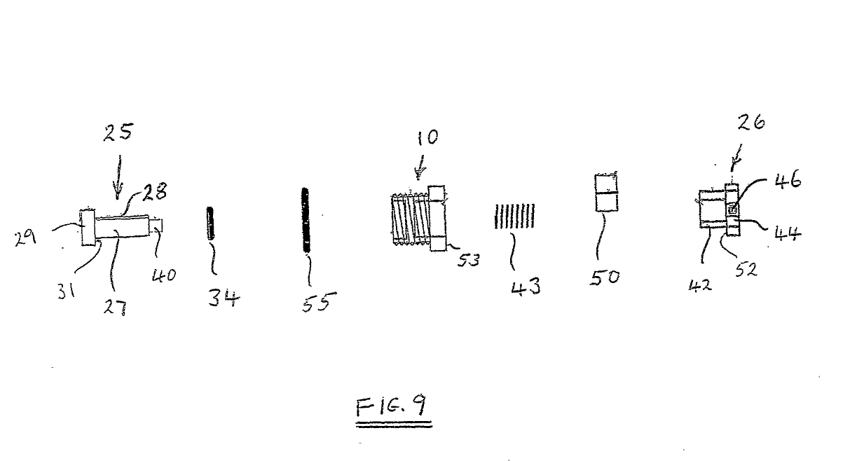

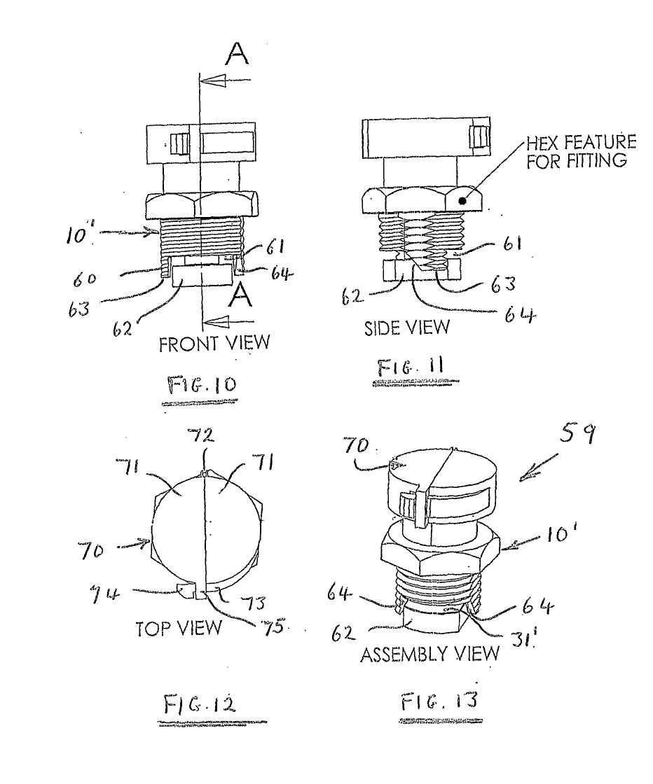

FIGS. 1, 2 and 3 are respectively side, end and perspective longitudinal section views of a boss portion of a valve assembly in accordance with the first embodiment of the present invention;

FIGS. 4 and 5 are respectively side and end views of part of a plunger assembly of the valve assembly;

FIG. 6 is a side view of another part of the plunger assembly;

FIGS. 7 and 8 are side and end views of a flexible collar of the valve assembly;

FIG. 9 is an exploded perspective view of the valve assembly of the first embodiment;

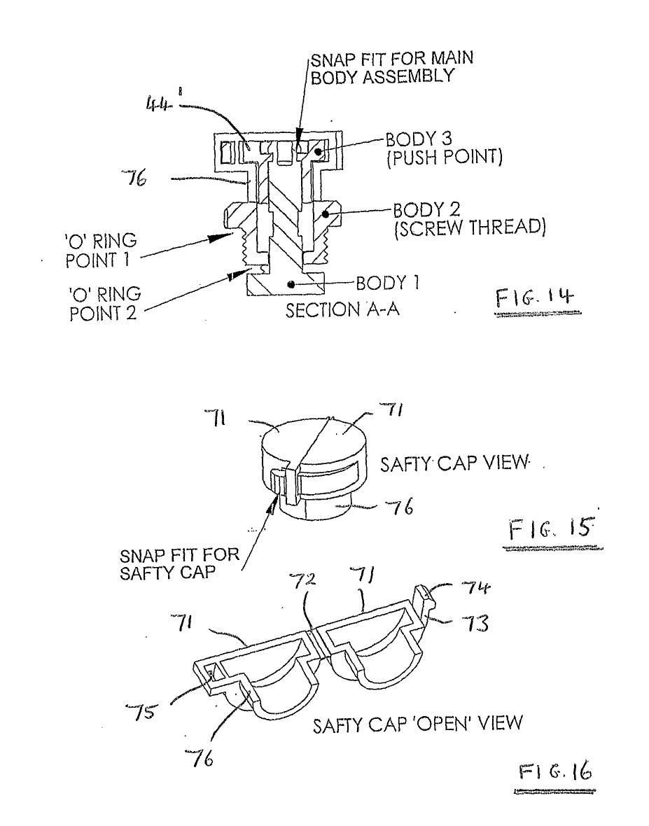

FIGS. 10 to 13 are respectively front, side, top and perspective views of a valve assembly in accordance with a second embodiment of the invention;

FIG. 14 is a section on the line AA of FIG. 10, and

FIGS. 15 and 16 are perspective views of a safety cap of the valve assembly of FIGS. 10 to 14 respectively in closed and open positions.

This embodiment of the invention relates to a valve assembly in the form of a radiator push button vent valve suitable for use with a radiator of a domestic gas fired central heating system.

The valve assembly comprises a support body in the form of a boss 10 and a plunger assembly 11 which is axially slideable within a bore 12 defined by the boss.

The boss 10 comprises an externally threaded section 13 and an hexagonal head 14.

The bore 12 of the boss is generally of circular cross-section and comprises two end section 15, 16 separated by an annular wall 17 having a central through passage 21. Additionally one 15 of the end sections comprises a pair of diametrically opposite lug formations 18 which extend longitudinally between the wall 17 and a respective lug end face 19 which lies slightly inwards from an end face 20 of the section 15.

Each lug formation 18 extends radially inwards by half of the radial extent of the wall section 17, that is half way between the radius of the bore 21 of the annular wall and the radius of the bore of the end section 15.

The plunger 11 comprises an inner valve section 25 which, in use, is exposed in part to the water in the radiator, and an outer section 26 which provides an operating button.

The inner section 25 comprises a central cylindrical stem portion 27 having a diameter which enables it to slide freely within but be supported and guided by the through passage 21 of the annular wall 17. Although generally cylindrical the stem portion has a flat zone 28 which extends the full length of the stem portion. That formation co-operates with the surface of the through passage 21 to provide a fluid flow passage for venting of air from the end section 15 to the end section 16 of the boss.

At one end of the stem portion 27 the plunger is provided with a head 29 of general cylindrical shape and a diameter which enables it to be supported and guided by the inner surface of the end section 15. Although generally circular in cross-section, the head section 29 is provided with two diametrically opposed flats 30 which enable it to fit and slide axially between the lug formations 18. The flats 30 co-operate with the lug formations to inhibit relative rotation of the boss and plunger assembly during relative axial movement between said first and second positions.

The annular shoulder 31 formed between the head 29 and stem 27 acts in the assembly as a seal surface to confront the annular surface region 32 which lies radially between the through passage 21 and the radially inner surface of each lug formation 18. The stem portion 17 supports an O ring seal 34 which rests against the shoulder 31 and provides a fluid seal between the confronting surfaces 31, 32 when the valve is in a closed condition.

At the other end of the stem portion 17 there is provided a cylindrical end section 40 of reduced diameter thereby to create an annular shoulder 41.

The outer section 26 of the plunger has a tubular body portion 42 of an outer diameter which enables it to slide within the end section 16 of the boss. The inner diameter of the body portion 42 is greater than the outer diameter of the aforedescribed stem portion 27 thereby to create an annular cavity which, in the assembly, contains a compression spring 43.

The outer section 26 of the plunger has a head 44 provided with a central aperture into which the end section 40 of the stem 27 is a tight fit. The head is provided with a radially extending screw-threaded aperture 45 for a screw 46 which engages the end section 40 to prevent axial separation of the plunger sections 25, 26.

The axial length of the outer section 26 is slightly greater than the axial distance between the annular seal surface 32 and lug end faces 19 of the boss. Accordingly, when the button is fully pressed to cause the end of the outer section 26 to seat against the wall 17, the annular seal face 31 of the plunger head will lie axially slightly beyond the end faces 19 of the lug formations 18. In that axial position the plunger can be rotated slightly, e.g. through 90°, so that the outer regions of the valve head 29, lying outwards of the O ring seal, confront the end faces 19 of the lug formations. At relative axial positions of the plunger assembly and boss lying between the aforementioned position, referred to herein as a second position, in the which the valve assembly head can be rotated as described, and a first position in which the valve is closed to fluid flow by virtue of presence of the seal 34 between the valve assembly head and the wall 17, relative rotation is prevented by the presence of the lug formations which will bear against the opposed flats 30 of the valve assembly head.

The compression spring 43 is of a length and compression characteristic such that when the valve assembly is in the aforementioned first position one end of the spring acts against the button head 44 and the other against the boss wall member 17 to maintain the O ring seal 34 under compression.

The body portion 42 of the plunger assembly outer section 26 is surrounded by a flexible plastics collar 50 having a longitudinal slit 51. In the assembly the collar lies axially between an inward facing shoulder 52 of the button head 44 and a confronting end face 53 of the head 14 of the boss 10. The axial length of the collar is less than the spacing between said confronting surfaces when the boss and plunger assembly lie relative to one another in said first position. Accordingly the collar acts to allow the valve to be opened slightly, but prevents the valve being opened fully to lie in the aforedescribed second position.

In use of the vent valve, the boss is fitted to the screw-threaded vent hole of a central heating radiator with an O ring seal 55 being provided between the hexagonal head 14 of the boss and a confronting surface of the radiator.

When the radiator is filled with water a seal formed by virtue of the O ring seal 34, maintained in compression by action of the compression spring 43, prevents water leaking from the radiator.

In the event of air venting being required, the button 44 is depressed, thereby allowing any gas within the radiator to escape via the resulting space between the confronting surfaces which are sealed by the O ring seal 34 when in a closed condition and through the passages created between the boss wall 17 and valve stem by virtue of the aforedescribed flat zone 28 of the valve stem. An aperture 54 provided in the button head 44 allows air to vent to atmosphere from the boss end section 16. On appearance of water, the button is immediately released thereby closing the seal 34 between the plunger head 29 and the boss wall 17.

The collar 50 serves to restrict axial travel of the button 44 along the length of the lugs 18. However, if the vent needs to be left open for a period of time such as during draining down or filling of the central heating system, the collar is unclipped to allow the button to be fully depressed and then rotated through 90°. This brings the plunger head 29 into a position at which radially outer portions of the shoulder 31 confront and rest against end faces 19 of the lug formations, thereby allowing the valve to remain in an open position despite release of pressure on the button.

To re-seal the valve, the plunger assembly is rotated further through 90° and the spring then acts to return the valve assembly to a closed condition. The collar is then replaced to surround the tubular body portion 42 of the plunger outer section 26.

In the second embodiment of the invention, shown in FIGS. 10 to 16, a valve assembly 59 comprises a boss 10′ having a stepped end 60 comprising two cut-outs 61. The side walls 64 of the cut-outs act as guide surfaces for the plunger end 62 which has a shape similar to that of the head section of the plunger, of FIG. 5. The distal end 63 of the boss 10′ serves as an abutment face to bear against the inner face 31′ of the plunger head and retain the valve in an open position.

The second embodiment differs from the first also in that it does not comprise a collar 50. Instead it is provided with a plastics safety cap 70 comprising two semi-cylindrical sections 71 hingedly connected by a thin plastics web 72. The two sections can be selectively held together by a tongue 73 having a toothed end 74 which can pass through and be retained by a location eye 75. The end 74 can be pressed radially inwards to allow opening of the two hingedly connected sections. In use the cap can encapsulate the plunger outer heard section 44′ and has a cylindrical spacer section 76 of a length which is sufficient to prevent the head section being urged inwards to move the valve from an open to a closed position. When the cap is removed, however, the valve is free to be moved to the open position and, if desired, rotated to lock in an open position with the plunger head face 31′ resting on the body section end face 63.

Although not illustrated, optionally the valve assembly of the second embodiment may be provided with a bias spring in a manner similar to that provided in accordance with the first embodiment.

1. A valve assembly comprising a support body, a plunger assembly movable relative to the support body in an axial direction parallel with a longitudinal axis of the plunger assembly and said plunger assembly being angularly movable relative to the support body about said longitudinal axis, seal means to provide a fluid seal between the support body and plunger assembly when support body and plunger assembly are in a first position relative to one another, bias means acting on the plunger assembly in said axial direction to urge the plunger assembly in a first direction relative to the support body towards said first position, a fluid flow passage to allow flow of fluid through the valve assembly when the plunger assembly has been moved relative to the support body away from said first position, said support body and plunger assembly having associated therewith respective abutment surfaces engagable with one another to hold the valve assembly in an open state when the plunger assembly has been moved relative to the support body in said axial direction away from said first position to a second position, said plunger assembly being angularly moveable relative to the support body when at said second position selectively to bring the abutment surfaces into mutual engagement to hold the plunger assembly in said second position and to release the plunger assembly for movement towards the first position under the action of the bias means.

2. A valve assembly according to claim 1 and comprising guide means to inhibit or restrict relative angular movement between the support body and plunger assembly over at least part of the length of axial movement of the plunger assembly relative to the support body from said first to said second position.

3. A valve assembly according to claim 2 wherein, at positions of the plunger assembly between said first and said second positions, the guide means allows a degree of relative angular movement but said degree of relative angular movement is less than the angular movement allowable when the plunger assembly is at said second position.

4. A valve assembly according to claim 2 wherein said guide means is integral with a portion of the valve assembly which defines a said abutment surface.

5. A valve assembly according claim 2 wherein the guide means comprises a formation which extends from one of the support body and plunger assembly.

6. A valve assembly according to claim 5 wherein an end region of said formation defines a said abutment surface.

7. A valve assembly according to claim 2 wherein the guide means inhibit or restricts relative angular movement when the plunger assembly is at said first position or between said first and second positions, and allows greater relative angular movement when the plunger assembly lies at or beyond said second position.

8. A valve assembly according to claim 1 wherein said bias means comprises a resilient component.

9. A valve assembly according to claim 8 wherein said bias means comprises a helical compression spring.

10. A valve assembly according to claim 1 wherein the support body comprises a recess to accommodate at least a part of the bias means.

11. A valve assembly according to claim 10 wherein said recess is an annular recess which contains part of the plunger assembly.

12. A valve assembly according to claim 1 and comprising a collar provided between a portion of the valve assembly and a portion of the support body.

13. A valve assembly according to claim 12 wherein said collar extends around the bias means and part of the plunger assembly.

14. A valve assembly according to claim 12 wherein the collar is provided with a slit which extends longitudinally, or is otherwise circumferentially discontinuous, whereby the collar may be removed and replaced from around the plunger assembly and/or bias means.

15. A valve assembly according to claim 12 wherein the axial length of the collar allows the plunger assembly to be moved relative to the support body only by a distance less than the distance between said first and second positions.

16. A valve assembly according to claim 15 wherein said collar is flexible or is otherwise constructed to be removable to allow the plunger assembly to be moved relative to the support body to lie in said second position.

17. A valve assembly according to claim 1 and comprising a removable limit device, such as a collar, which in a first condition allows a plunger assembly to be moved only part of the distance from said first to said second position but which allows movement to the second position when in a second condition.

18. A valve assembly according to claim 1 and comprising location means for inter-connecting the bias means and plunger assembly in a manner whereby the bias means may exert a bias force on the plunger assembly.

19. A valve assembly according to claim 18 wherein the bias means is of a compression type and said location means is provided by a head portion of the plunger assembly.

20. A valve assembly according to claim 19 wherein said head portion is an outer head portion which, in use, lies external of the fluid path to which the valve assembly may be connected.

21. A valve assembly according to claim 1 wherein the fluid flow passage of the valve assembly is defined by a space between confronting surfaces of the support body and plunger assembly.

22. A valve assembly according to claim 1 wherein an outer head portion of the plunger assembly is provided with an outer profile selected to facilitate ease of rotation of the plunger assembly relative to the support body when the plunger assembly is in said second position.

23. A valve assembly according to claim 1 wherein the support body comprises a boss having a screw-threaded formation for attachment to part of a fluid flow path.

24. A valve assembly according to claim 23 wherein said boss comprises an abutment face for a seal which, in an assembly with a fluid flow path, is compressed between the abutment face and structure of the fluid flow path.

25. A valve assembly according to claim 1 and comprising an O ring seal to provide a fluid seal when the plunger assembly is in said first position relative to the support body.

26. A valve assembly according to claim 25 wherein said seal is retained relative to one of the confronting surfaces of the plunger assembly and support body between which it is operable to effect a seal.

27. A valve assembly according to claim 1 wherein the outer diameter of a support body is less than 5 centimetres.

28. A valve assembly according to claim 1 wherein the support body comprises a screw-threaded outer formation having a diameter less than 2.5 centimetres.

29. A valve assembly according to claim 28 wherein said diameter is less than 2 centimetres.

30. A valve assembly according to claim 1 wherein locking means is provided and is operable in use to retain the valve assembly in said first, closed position against any negative pressure forces exerted on the valve assembly.

31. A valve assembly according to claim 1 and comprising a selectively removable and replaceable safety lock member which, when in situ, prevents movement of the plunger assembly from said first, closed position and which is removable to allow movement from said first position.

32. A valve assembly according to claim 31 wherein the safety lock member comprises two semi-cylindrical sections hingedly interconnected.

33. A valve assembly according to claim 31 wherein the safety lock member comprises a snap fit connection for selectively holding two sections of the cap in a closed condition.

34-37. (canceled)
